(19) United States
(12) Patent Application Publication
(10) Pub. No.: US 2026/0111258 A1
(43) Pub. Date: Apr. 23, 2026

(54) METHOD AND SYSTEM FOR PREPARING AND EXECUTING JOBS

(71) Applicant: HCL Technologies Italy S.p.A, Rome (IT)

(72) Inventors: Longobardi Giuseppe, Rome (IT); Baglioni Cecilia, Rome (IT); Cascioli Valerio, Rome (IT); D’amore Grazia, Rome (IT); Falsi paolo, Rome (IT); Iezzi Alessandro, Rome (IT); Montervino Dario, Rome (IT); Tondi Danilo, Rome (IT)

(21) Appl. No.: 18/921,116

(22) Filed: Oct. 21, 2024

(51) Int. Cl. G06F 9/48

(52) U.S. Cl. CPC G06F 9/4881; G06F 2209/485

(57) ABSTRACT

This disclosure relates to method and system for preparing and executing jobs. The method includes receiving a set of jobs for execution. Each of the set of jobs is scheduled for execution at a predefined execution time. Each of the set of jobs comprises an associated set of job constraints The method further includes assigning a priority level to each of the set of jobs based on the set of job constraints. The priority level is one of a high priority level or a normal priority level. The method further includes preparing each of a set of high priority jobs for execution prior to the predefined execution time. The priority level assigned to each of the set of high priority jobs is the high priority level The method further includes executing each of the set of jobs at the predefined execution time.

### TECHNICAL FIELD

This disclosure relates generally to job scheduling in a computing environment, and more particularly to method and system for preparing and executing jobs.

### BACKGROUND

In computing, a job is a unit of computational work that includes one or more tasks (i.e., steps). The job is submitted to a job execution system (for example, Job Execution System (JES), JES2, etc.) for execution (i.e., processing). In a an Operating System (OS) environment (for example, z/OS®environment) there are several means of performing a job submission. Job submission is generally managed by a scheduling system. The scheduling system identifies a set of conditions to be met prior to job execution and a predefined time for job submission. At present, when a scheduling system is used to orchestrate the job submission, the job is submitted when all the conditions are validated and the predefined time is matched.

However, there are some preparation activities to be performed on the job executing system which may create an execution queue, and cause a delay in the predefined execution time for the job. Further, the delay may negatively affect the job execution of critical and high priority jobs. The conventional scheduling systems fail to anticipate the job submission which may result in delay of the job execution as the job execution is halted until the predefined execution time.

Thus, the present invention is directed to overcome one or more limitations stated above or any other limitations associated with the known arts.

### SUMMARY

In one embodiment, a method for preparing and executing jobs is disclosed. In one example, the method may include receiving a set of jobs for execution. Each of the set of jobs is scheduled for execution at a predefined execution time. Each of the set of jobs may include an associated set of job constraints. Further, the method may include assigning a priority level to each of the set of jobs based on the set of job constraints. The priority level is one of a high priority level or a normal priority level. The method may further include preparing each of a set of high priority jobs for execution prior to the predefined execution time. The priority level assigned to each of the set of high priority jobs is the high priority level. The method may further include executing each of the set of jobs at the predefined execution time.

In another embodiment, a system for preparing and executing jobs is disclosed. In one example, the system may include a processor and a memory communicatively coupled to the processor. The memory may store processor-executable instructions, which, on execution, may cause the processor to receive a set of jobs for execution. Each of the set of jobs is scheduled for execution at a predefined execution time. Each of the set of jobs may include an associated set of job constraints. The processor-executable instructions, on execution, may further cause the processor to assign a priority level to each of the set of jobs based on the set of job constraints. The priority level is one of a high priority level or a normal priority level. The processor-executable instructions, on execution, may further cause the processor to prepare each of a set of high priority jobs for execution prior to the predefined execution time. The priority level assigned to each of the set of high priority jobs is the high priority level. The processor-executable instructions, on execution, may further cause the processor to execute each of the set of jobs at the predefined execution time.

In another embodiment, a non-transitory computer-readable medium storing computer-executable instructions for preparing and executing jobs is disclosed. In one example, the stored instructions, when executed by a processor, may cause the processor to perform operations including receiving a set of jobs for execution. Each of the set of jobs is scheduled for execution at a predefined execution time. Each of the set of jobs includes an associated set of job constraints. The operations may further include assigning a priority level to each of the set of jobs based on the set of job constraints. The priority level is one of a high priority level or a normal priority level. The operations may further include preparing each of a set of high priority jobs for execution prior to the predefined execution time. The priority level assigned to each of the set of high priority jobs is the high priority level. The operations may further include executing each of the set of jobs at the predefined execution time.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a flow diagram of an exemplary control logic of job processing, in accordance with some embodiments of the present disclosure.

FIG. 2 is a block diagram of an exemplary system for preparing and executing jobs, in accordance with some embodiments of the present disclosure.

FIG. 3 illustrates a functional block diagram of an exemplary system for preparing and executing jobs, in accordance with some embodiments of the present disclosure.

FIG. 4 illustrates a flow diagram of an exemplary process for preparing and executing jobs, in accordance with some embodiments of the present disclosure.

FIG. 5 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

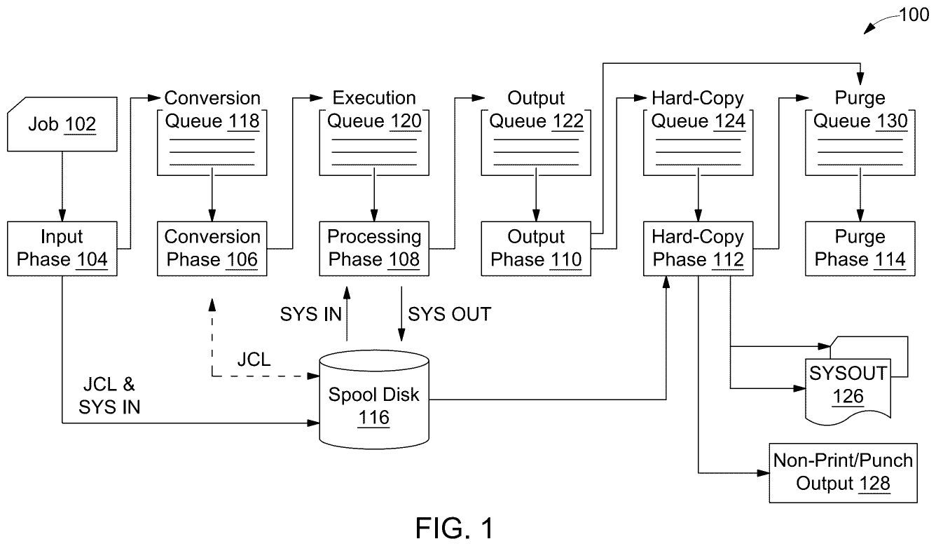

Referring now to FIG. 1, an exemplary job execution system 100 for processing a job 102 is illustrated, in accordance with some embodiments of the present disclosure. The job 102 may be a computational job including one or more tasks to be executed in response to user inputs. For example, the user inputs may include mouse clicks or a set of commands intended to open a word processing program. In such a scenario, the job 102 may correspond to opening the word processing program. The job 102 may be executed by the job execution system 100.

The job execution system 100 may be implemented by a computing device (such as server, desktop, laptop, notebook, netbook, tablet, smartphone, mobile phone, or any other computing device). The computing device may include an Operating System (OS; such as z/OS®). The OS may be preconfigured with the job execution system 100 (for example, Job Execution System (JES), JES2, etc.).

The job execution system 100 may execute jobs in a plurality of phases. The plurality of phases may include an input phase 104, a conversion phase 106, a processing phase 108, an output phase 110, a hard-copy phase 112, and a purge phase 114.

The input phase 104 may include receiving, by the job execution system 100, the job 102 for processing from input devices (for example, card readers, remote terminals, and the like). The job execution system 100 may assign a job identifier (ID) to the job 102. Additionally, the job execution system 100 may send a Job Control Language (JCL) of the job 102 and input data (i.e., SYSIN data) for the job 102 to a spool disk 116. Further, the job execution system 100 may add the job 102 to a conversion queue 118. The conversion queue 118 may include one or more jobs that are waiting to be run (i.e., initiated).

For the conversion phase 106, the job execution system 100 may receive the job 102 from the conversion queue 118 and may retrieve the JCL of the job 102 from the spool disk 116. The conversion phase 106 may include transforming, by the job execution system 100, JCL of the job 102 into converter/interpreter text that is in a readable format for the job execution system 100 and a job scheduling system. Additionally, the job execution system 100 may send the converter/interpreter text of the job 102 to the spool disk 116. Further, the job execution system 100 may add the job 102 to an execution queue 120. The execution queue 120 may include one or more jobs that are currently running and are waiting to be executed (i.e., processed).

For the processing phase 108, the job execution system 100 may receive the job 102 from the execution queue 120. The processing phase 108 may include allocating, by the job execution system 100, resources for processing the job 102 via an initiator and managing the processing through the job execution system 100. Based on a user command associated with the job 102, the job execution system 100 may search for a job, perform message or command processing, or access a SYSIN or SYSOUT (i.e., output data of the job 102) data set from the spool disk 116. Further, upon completing the processing, the job execution system 100 may add the output data of the job 102 to an output queue 122.

For the output phase 110, the job execution system 100 may receive the output data of the job 102 from the output queue 122. The output phase 110 may include processing, by the job execution system 100, the output data of the job 102. The output data of the job 102 includes system messages that must be printed and data sets requested by the user that must be printed or punched. Upon completion of job processing, the job execution system 100 may analyze characteristics of the output data of the job 102 in terms of associated output class and device setup requirements. Further, the job execution system 100 may group data sets with similar characteristics. Further, the job execution system 100 may add the output data of the job 102 to a hard copy queue 124 for print or punch processing.

For the hard copy phase 112, the job execution system 100 may receive the output data of the job 102 from the hard copy queue 124. The hard copy phase 112 may include generating (i.e., printing), by the job execution system 100, the output data of the job 102. The job execution system 100 may print SYSOUT 126 (i.e., print/punch data sets) of the output data and may also generate non-print/punch output 128. Upon completing the processing of the output data of the job 102, the job execution system 100 may add the job 102 on a purge queue 130.

For the purge phase 114, the job execution system 100 may receive the job 102 from the purge queue 130. The purge phase 114 may include releasing, by the job execution system 100, spool space assigned to the job 102, making the spool space available for allocation to subsequent jobs. Further, the job execution system 100 may issue a message to the user indicating that the job 102 has been purged from the job execution system 100.

However, the job execution system 100 may receive jobs from the job scheduling system. The jobs may be arranged in an order (based on constraints, for example, on predecessor-successor dependency chain, time dependency, resources availability, etc.) through a scheduler logic in a plan database. The job scheduling system may select a job for submission only when each of the constraints is met, including the time dependency. When it is time (assuming that planned execution time is the only unmet constraint for the job), the job scheduling system may submit the job to the job execution system 100. The job execution system 100 may, in turn, need to perform some preliminary activities on the submitted job, in order to have the job ready for real execution. Alongside, the job execution system 100 may also keep building the execution queue as more jobs are received. This will add some delay to execution of the job.

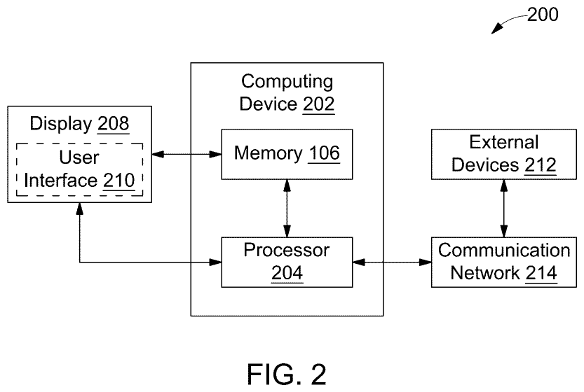

Referring now to FIG. 2, an exemplary system 200 for preparing and executing jobs is illustrated, in accordance with some embodiments of the present disclosure. The system 200 may include a computing device 202 (for example, server, desktop, laptop, notebook, netbook, tablet, smartphone, mobile phone, or any other computing device), in accordance with some embodiments of the present disclosure. The computing device 202 may prepare and execute jobs. It should be noted that, in some embodiments, the computing device 202 may receive a set of jobs for execution. It should be noted that each of the set of jobs is scheduled for execution at a predefined execution time. It should be noted that each of the set of jobs includes an associated set of job constraints. The computing device 202 may prepare and execute jobs using a job scheduling system and a job executing system in a given OS (for example z/OS).

As will be described in greater detail in conjunction with FIG. 2-5, the computing device 202 may receive a set of jobs for execution. Each of the set of jobs may be scheduled for execution at a predefined execution time. Each of the set of jobs may include an associated set of job constraints. The computing device 202 may further assign a priority level to each of the set of jobs based on the set of job constraints. It should be noted that the priority level may be one of a high priority level or a normal priority level. The computing device 202 may further prepare each of a set of high priority jobs for execution prior to the predefined execution time. It should be noted that the priority level assigned to each of the set of high priority jobs may be the high priority level. The computing device 202 may further execute each of the set of jobs at the predefined execution time.

In some embodiments, the computing device 202 may include one or more processors 204 and a memory 206. Further, the memory 206 may store instructions that, when executed by the one or more processors 204, cause the one or more processors 204 to prepare and execute jobs, in accordance with aspects of the present disclosure. The memory 206 may also store various data (for example, a set of jobs, a predefined execution time of each of the set of jobs, a set of job constraints, an execution queue, and the like) that may be captured, processed, and/or required by the system 200. The memory 206 may be a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random Access Memory (DRAM), Static Random-Access memory (SRAM), etc.).

The system 200 may further include a display 208. The system 200 may interact with a user via a user interface 210 accessible via the display 208. The system 200 may also include one or more external devices 212. In some embodiments, the computing device 202 may interact with the one or more external devices 212 over a communication network 214 for sending or receiving various data. The external devices 212 may include, but may not be limited to, a remote server, a digital device, or another computing system.

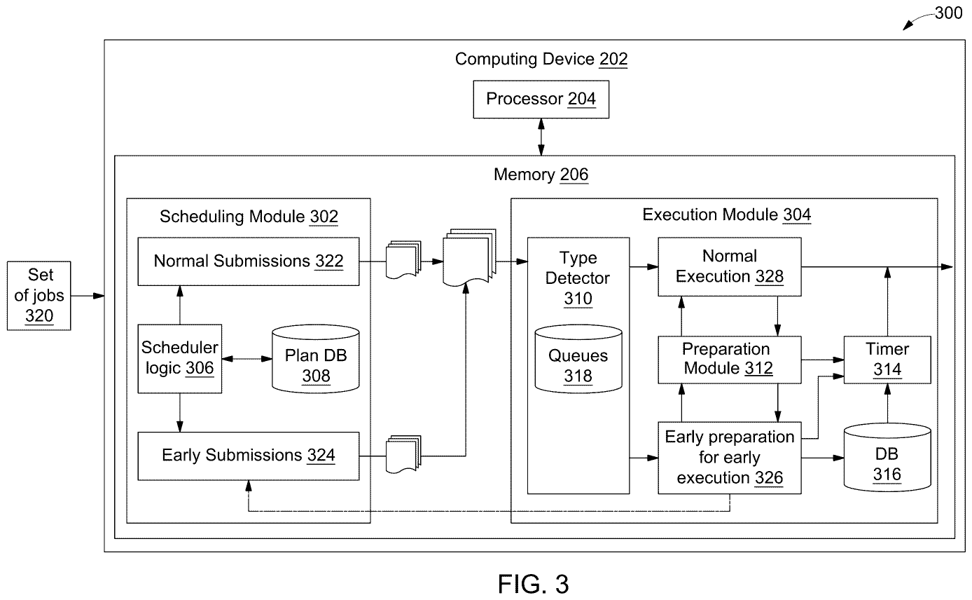

Referring now to FIG. 3, a functional block diagram of various modules to prepare and execute jobs is illustrated, in accordance with some embodiments of the present disclosure. FIG. 3 is explained in conjunction with FIG. 2. The system 200 may include, within the memory 206, a scheduling module 302 and an execution module 304 (analogous to the job execution system 100). The scheduling module 302 may include a scheduler logic 306 and a plan database 308. The execution module 304 may include a type detector 310, a preparation module 312, a timer 314, and a database 316. The type detector 310 may include execution queues 318 (analogous to the execution queue 120).

The scheduling module 302 may receive a set of jobs 320 for execution. It may be noted that each of the set of jobs 320 may include an associated set of job constraints. Based on the associated set of job constraints, the scheduling module 302 may schedule each of the set of jobs 320 for execution at a predefined execution time. By way of an example, the associated set of job constraints may include a predecessor dependency chain, a successor dependency chain, a time required for preparation, a time required for execution, an availability of resources for execution, and the like. Further, the scheduling module 302 may store the set of jobs 320 in the plan database 308.

Further, the scheduling module 302 may retrieve the set of jobs 320 from the plan database 308. The scheduling module 302 may then assign a priority level to each of the set of jobs 320 based on the set of job constraints. The priority level may be one of a high priority level or a normal priority level. The priority level may be assigned via one of the scheduler logic 306 (i.e., a predefined logic) or a classification model (for example, k-nearest neighbours (KNN), logistic regression, Support Vector Machine (SVM), decision trees, naive bayes, gradient boosting, random forest, Artificial Neural Network (ANN), or the like). The scheduler logic 306 may include a set of predefined rules for categorizing a job into one of a high priority level or a normal priority level based on the associated set of job constraints. In an embodiment, the high priority level may be assigned to a job for which each of the set of constraints is validated (i.e., the job is only waiting for the predefined execution time). Thus, the set of jobs 320 may be classified into a set of high priority jobs (i.e., jobs assigned the high priority level) and a set of normal priority jobs (i.e., jobs assigned the normal priority level). In an embodiment, there may be more than two priority levels (for example, the high priority level, a medium priority level, and a low priority level).

Further, the scheduling module 302 may assign a delay flag to each of the set of high priority jobs. Thus, each job which is categorized under a high priority level may be assigned a delay flag. The delay flag may be a label or an ID that makes the job identifiable as a high priority job. Further, the scheduling module 302 may submit the set of jobs 320 for job execution to the execution module 304. There may be two modes of submission, namely, a normal submission mode (through step 322) and an early submission mode (through step 324). The scheduling module 302 may submit each of the set of high priority jobs (i.e., jobs which include the assigned delay flag) through the early submission mode, at the step 324. The early submission mode may include submitting a high priority job at an early submission time to initiate preparation for job execution. In other words, in the early submission mode, the scheduling module 302 may submit the high priority job for execution to the execution module 304 at a time which is prior to the predefined execution time (for example, 1 minute or a few seconds in advance). Additionally, the scheduling module 302 may send a specific notification (or instruction) to the execution module 304 to wait for the predefined execution time to process the high priority job, rather than processing and running the high priority job right away.

The normal submission mode may include submitting a normal priority job (i.e., a job without any assigned delay flag) to the execution module 304 upon reaching the predefined execution time of that normal priority job. Thus, a normal priority job may be submitted at the predefined execution time while a high priority job may be submitted prior to the predefined execution time for early preparation.

Further, the execution module 304 may store the received set of jobs 320 in the execution queues 318 within the type detector 310. the type detector 310 may retrieve each of the set of jobs 320 from the queues 318 and may detect the set of high priority jobs from the set of jobs 320 through the delay flag, to initiate preparation for job execution (i.e., early preparation for early execution). The type detector 310 may obtain a current time from the timer 314. The type detector 310 may compare the predefined threshold time of each of the set of jobs 320 in the queues 318 with the current time.

Further, based on the comparison, the type detector 310 may send each of the set of high priority jobs to the preparation module 312, prior to the corresponding predefined execution time, to perform the early preparation for early execution, at step 326. Further, the preparation module 312 may prepare each of the set of high priority jobs for execution prior to the predefined execution time. Further, the preparation module 312 may add each of prepared high priority jobs from the set of high priority jobs to the database 316 (i.e., an early execution queue). The database 316 may include the prepared high priority jobs. Each of the prepared high priority jobs may be arranged in the database 316 in an order based on the predefined execution time. When the current time reaches the predefined execution time, each of the prepared high priority jobs may be executed by the execution module 304.

Further, when the current time reaches the predefined execution time of a normal priority job, the type detector 310 may send the normal priority job to the preparation module 320 to perform normal execution, at step 328. The normal execution includes initiating preparation of a normal priority job at the predefined execution time. Thus, through the normal execution, the preparation of the job may be initiated following which the job will be executed by the execution module 304. On the other hand, through the early preparation, the preparation of the job may be performed prior to the predefined execution time. Thus, when the current time reaches the predefined execution time, the job prepared through the early preparation may straightaway be executed, thereby saving the time required for preparation.

In some embodiments, the execution module 304 may periodically determine an early submission time for each of the set of high priority jobs based on a current job execution workload. Further, the execution module 304 may send information of the current job execution workload to the scheduler module 302. Further, the scheduler module 302 may submit each of the set of high priority jobs at the early submission time to initiate the early preparation for job execution. The early submission time may be a waiting time (for example, 1 minute, 3 minutes, etc.) for submitting the high priority job to the execution module 304 when the execution module 304 has a high current job execution workload (i.e., the current job execution workload may be greater than a predefined threshold workload). This may form a feedback loop between the execution module 304 and the scheduling module 302, facilitating determination of the early submission time to refine the delay setting of the scheduling module 302 with respect to job submission.

It should be noted that all such aforementioned modules 302-304 may be represented as a single module or a combination of different modules. Further, as will be appreciated by those skilled in the art, each of the modules 302-304 may reside, in whole or in parts, on one device or multiple devices in communication with each other. In some embodiments, each of the modules 302-304 may be implemented as dedicated hardware circuit comprising custom application-specific integrated circuit (ASIC) or gate arrays, off-the-shelf semiconductors such as logic chips, transistors, or other discrete components. Each of the modules 302-304 may also be implemented in a programmable hardware device such as a field programmable gate array (FPGA), programmable array logic, programmable logic device, and so forth. Alternatively, each of the modules 302 304 may be implemented in software for execution by various types of processors (e.g., processor 204). An identified module of executable code may, for instance, include one or more physical or logical blocks of computer instructions, which may, for instance, be organized as an object, procedure, function, or other construct. Nevertheless, the executables of an identified module or component need not be physically located together, but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for preparing and executing jobs. For example, the exemplary system 200 and the associated computing device 202 may prepare and execute jobs by the processes discussed herein. In particular, as will be appreciated by those of ordinary skill in the art, control logic and/or automated routines for performing the techniques and steps described herein may be implemented by the system 200 and the associated computing device 202 either by hardware, software, or combinations of hardware and software. For example, suitable code may be accessed and executed by the one or more processors on the system 200 to perform some or all of the techniques described herein. Similarly, application specific integrated circuits (ASICs) configured to perform some or all of the processes described herein may be included in the one or more processors on the system 200.

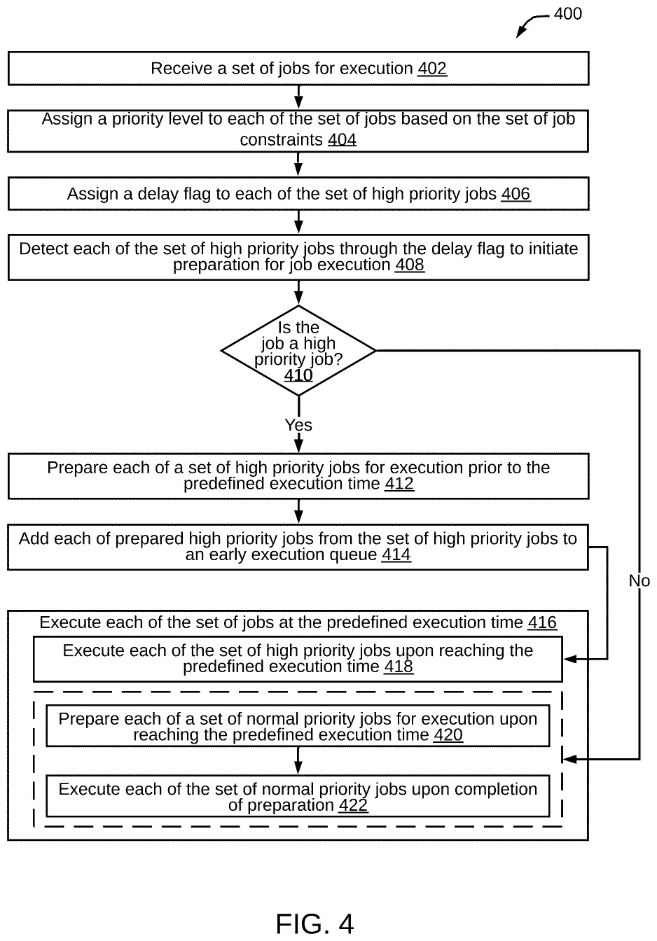

Referring now to FIG. 4, an exemplary process 400 for preparing and executing jobs is depicted via a flowchart, in accordance with some embodiments of the present disclosure. The process 400 may be implemented by the computing device 202 of the system 200. The process 400 may include receiving, by a scheduling module (such as the scheduling module 302), a set of jobs (for example, the set of jobs 320) for execution, at step 402. The set of jobs may be scheduled for execution at a predefined execution time. Each of the set of jobs may include an associated set of job constraints.

Further, the process 400 may include assigning, by the scheduling module, a priority level to each of the set of jobs based on the set of job constraints, at step 404. In an embodiment, the priority level may be one of a high priority level or a normal priority level. It may be noted that the priority level may be assigned to each of the set of jobs based on the set of job constraints via one of a predefined logic (for example, the scheduler logic 306) or a classification model. Thus, a set of high priority jobs and a set of normal priority jobs may be obtained. The priority level assigned to each of the set of high priority jobs is the high priority level, and the priority level assigned to each of the set of normal priority jobs is the normal priority level. By way of an example, the set of job constraints may include, but may not be limited to, a predecessor dependency chain, a successor dependency chain, a time required for preparation, a time required for execution, and an availability of resources for execution.

Further, the process 400 may include assigning, by the scheduling module, a delay flag to each of the set of high priority jobs, at step 406. Further, the process 400 may include detecting, by an execution module (such as the execution module 304), each of the set of high priority jobs through the delay flag to initiate preparation for job execution, at step 408.

At step 410, a check may be performed to determine whether a received job from the set of jobs is a high priority job (i.e., one of the set of high priority jobs). If the job is determined to be a high priority job, the process 400 may proceed to step 412 (“Yes” path). At step 412, the process 400 may include preparing, by the execution module, each of the set of high priority jobs for execution prior to the predefined execution time. The process 400 may further include adding, by the execution module, each of prepared high priority jobs from the set of high priority jobs to an early execution queue (such as the early execution queue stored in the database 316), at step 414. The early execution queue may include the prepared high priority jobs. Each of the high priority jobs in the early execution queue may be arranged in an order based on the predefined execution time. Further, the process 400 may include executing, by the execution module, each of the set of jobs at the predefined execution time, at step 416. The step 416 of the process 400 may include executing, by the execution module, each of the set of high priority jobs upon reaching the predefined execution time, at step 418.

Returning back to the step 410, if the job is determined to be a normal priority job, the process 400 may proceed to step 420 of the step 416 (“No” path). At step 420, the process 400 may include preparing, by the execution module, each of a set of normal priority jobs for execution upon reaching the predefined execution time. Further, the step 416 of the process 400 may include executing, by the execution module, each of the set of normal priority jobs upon completion of preparation. Thus, a high priority job may be prepared prior to the predefined execution time, while for a normal priority job, the job preparation may be initiated only upon reaching the predefined execution time. The high priority job may be executed at the predefined execution time, while the normal priority job may be executed only after the job preparation is complete. Thus, time for job preparation may be saved for a high priority job, thus enabling a faster overall execution.

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

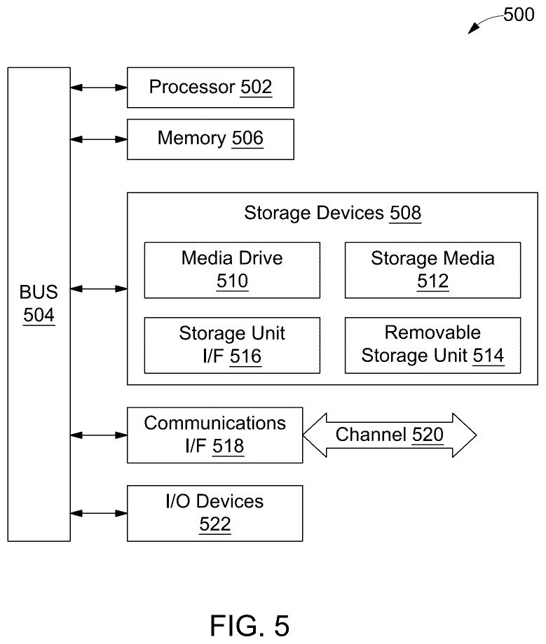

The disclosed methods and systems may be implemented on a conventional or a general-purpose computer system, such as a personal computer (PC) or server computer. Referring now to FIG. 5, an exemplary computing system 500 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 500 may represent, for example, a user device such as a desktop, a laptop, a mobile phone, personal entertainment device, DVR, and so on, or any other type of special or general-purpose computing device as may be desirable or appropriate for a given application or environment. The computing system 500 may include one or more processors, such as a processor 502 that may be implemented using a general or special purpose processing engine such as, for example, a microprocessor, microcontroller or other control logic. In this example, the processor 502 is connected to a bus 504 or other communication medium. In some embodiments, the processor 502 may be an Artificial Intelligence (AI) processor, which may be implemented as a Tensor Processing Unit (TPU), or a graphical processor unit, or a custom programmable solution Field-Programmable Gate Array (FPGA).

The computing system 500 may also include a memory 506 (main memory), for example, Random Access Memory (RAM) or other dynamic memory, for storing information and instructions to be executed by the processor 502. The memory 506 also may be used for storing temporary variables or other intermediate information during execution of instructions to be executed by the processor 502. The computing system 500 may likewise include a read only memory (“ROM”) or other static storage device coupled to bus 504 for storing static information and instructions for the processor 502.

The computing system 500 may also include a storage device 508, which may include, for example, a media drive 510 and a removable storage interface. The media drive 510 may include a drive or other mechanism to support fixed or removable storage media, such as a hard disk drive, a floppy disk drive, a magnetic tape drive, an SD card port, a USB port, a micro USB, an optical disk drive, a CD or DVD drive (R or RW), or other removable or fixed media drive. A storage media 512 may include, for example, a hard disk, magnetic tape, flash drive, or other fixed or removable medium that is read by and written to by the media drive 510. As these examples illustrate, the storage media 512 may include a computer-readable storage medium having stored there in particular computer software or data.

In alternative embodiments, the storage devices 508 may include other similar instrumentalities for allowing computer programs or other instructions or data to be loaded into the computing system 500. Such instrumentalities may include, for example, a removable storage unit 514 and a storage unit interface 516, such as a program cartridge and cartridge interface, a removable memory (for example, a flash memory or other removable memory module) and memory slot, and other removable storage units and interfaces that allow software and data to be transferred from the removable storage unit 514 to the computing system 500.

The computing system 500 may also include a communications interface 518. The communications interface 518 may be used to allow software and data to be transferred between the computing system 500 and external devices. Examples of the communications interface 518 may include a network interface (such as an Ethernet or other NIC card), a communications port (such as for example, a USB port, a micro-USB port), Near field Communication (NFC), etc. Software and data transferred via the communications interface 518 are in the form of signals which may be electronic, electromagnetic, optical, or other signals capable of being received by the communications interface 518. These signals are provided to the communications interface 518 via a channel 520. The channel 520 may carry signals and may be implemented using a wireless medium, wire or cable, fiber optics, or another communications medium. Some examples of the channel 520 may include a phone line, a cellular phone link, an RF link, a Bluetooth link, a network interface, a local or wide area network, and other communications channels.

The computing system 500 may further include Input/Output (I/O) devices 522. Examples may include, but are not limited to a display, keypad, microphone, audio speakers, vibrating motor, LED lights, etc. The I/O devices 522 may receive input from a user and also display an output of the computation performed by the processor 502. In this document, the terms “computer program product” and “computer-readable medium” may be used generally to refer to media such as, for example, the memory 506, the storage devices 508, the removable storage unit 514, or signal(s) on the channel 520. These and other forms of computer-readable media may be involved in providing one or more sequences of one or more instructions to the processor 502 for execution. Such instructions, generally referred to as “computer program code” (which may be grouped in the form of computer programs or other groupings), when executed, enable the computing system 500 to perform features or functions of embodiments of the present invention.

In an embodiment where the elements are implemented using software, the software may be stored in a computer-readable medium and loaded into the computing system 500 using, for example, the removable storage unit 514, the media drive 510 or the communications interface 518. The control logic (in this example, software instructions or computer program code), when executed by the processor 502, causes the processor 502 to perform the functions of the invention as described herein.

Thus, the disclosed method and system try to overcome the technical problem of preparing and executing jobs. The disclosed method and system may receive a set of jobs for execution. Each of the set of jobs is scheduled for execution at a predefined execution time. Each of the set of jobs includes an associated set of job constraints. Further, the disclosed method and system may assign a priority level to each of the set of jobs based on the set of job constraints. The priority level is one of a high priority level or normal priority level. Moreover, the disclosed method and system may prepare each of a set of high priority jobs for execution prior to the predefined execution time. The priority level assigned to each of the set of high priority jobs is the high priority level. Thereafter, the disclosed method and system may execute each of the set of jobs at the predefined execution time.

As will be appreciated by those skilled in the art, the techniques described in the various embodiments discussed above are not routine, or conventional, or well understood in the art. The techniques provide an algorithm in which a job can run at the planned time with a reduced delay compared to the present techniques that have a processing delay due to job network transfer, queuing for job preparation activities, and preparation time on JES side. Additionally, the techniques may process the high priority jobs prior to the execution time in order to reduce the overall execution time.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system for preparing and executing jobs. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for preparing and executing jobs, the method comprising:
receiving, by a computing device, a set of jobs for execution, wherein each of the set of jobs is scheduled for execution at a predefined execution time, and wherein each of the set of jobs comprises an associated set of job constraints;
assigning, by the computing device, a priority level to each of the set of jobs based on the set of job constraints, wherein the priority level is one of a high priority level or a normal priority level;
preparing, by the computing device, each of a set of high priority jobs for execution prior to the predefined execution time, wherein the priority level assigned to each of the set of high priority jobs is the high priority level; and
executing, by the computing device, each of the set of jobs at the predefined execution time.

2. The method of claim 1, wherein assigning the priority level comprises assigning, via one of a predefined logic or a classification model, the priority level to each of the set of jobs based on the set of job constraints.

3. The method of claim 1, wherein the set of job constraints comprises a predecessor dependency chain, a successor dependency chain, a time required for preparation, a time required for execution, and an availability of resources for execution.

4. The method of claim 1, further comprising:
assigning a delay flag to each of the set of high priority jobs; and
detecting each of the set of high priority jobs through the delay flag to initiate preparation for job execution.

5. The method of claim 1, further comprising adding each of prepared high priority jobs from the set of high priority jobs to an early execution queue, wherein the early execution queue comprises the prepared high priority jobs, and wherein each of the prepared high priority jobs is arranged in an order based on the predefined execution time.

6. The method of claim 1, further comprising:
periodically determining an early submission time for each of the set of high priority jobs based on a current job execution workload; and
submitting each of the set of high priority jobs at the early submission time to initiate preparation for job execution.

7. The method of claim 1, wherein executing each of the set of jobs at the predefined execution time comprises executing each of the set of high priority jobs upon reaching the predefined execution time.

8. The method of claim 1, wherein executing each of the set of jobs at the predefined execution time comprises:
preparing each of a set of normal priority jobs for execution upon reaching the predefined execution time, wherein the priority level assigned to each of the set of normal priority jobs is the normal priority level; and
executing each of the set of normal priority jobs upon completion of preparation.

9. A system for preparing and executing jobs, the system comprising:
a processor; and
a memory communicatively coupled to the processor, wherein the memory stores processor instructions, which when executed by the processor, cause the processor to:
receive a set of jobs for execution, wherein each of the set of jobs is scheduled for execution at a predefined execution time, and wherein each of the set of jobs comprises an associated set of job constraints;
assign a priority level to each of the set of jobs based on the set of job constraints, wherein the priority level is one of a high priority level or a normal priority level;
prepare each of a set of high priority jobs for execution prior to the predefined execution time, wherein the priority level assigned to each of the set of high priority jobs is the high priority level; and
execute each of the set of jobs at the predefined execution time.

10. The system of claim 9, wherein to assign the priority level the processor instructions, on execution, further cause the processor to assign via one of a predefined logic or a classification model, the priority level to each of the set of jobs based on the set of job constraints.

11. The system of claim 9, wherein the set of job constraints comprises a predecessor dependency chain, a successor dependency chain, a time required for preparation, a time required for execution, and an availability of resources for execution.

12. The system of claim 9, wherein the processor instructions, on execution, further cause the processor to:
assign a delay flag to each of the set of high priority jobs; and
detect each of the set of high priority jobs through the delay flag to initiate preparation for job execution.

13. The system of claim 9, wherein the processor instructions, on execution, further cause the processor to add each of prepared high priority jobs from the set of high priority jobs to an early execution queue, wherein the early execution queue comprises the prepared high priority jobs, and wherein each of the prepared high priority jobs is arranged in an order based on the predefined execution time.

14. The system of claim 9, wherein the processor instructions, on execution, further cause the processor to:
periodically determine an early submission time for each of the set of high priority jobs based on a current job execution workload; and
submit each of the set of high priority jobs at the early submission time to initiate preparation for job execution.

15. The system of claim 9, wherein to execute each of the set of jobs at the predefined execution time, the processor instructions, on execution, further cause the processor to:
executing each of the set of high priority jobs upon reaching the predefined execution time.

16. The system of claim 9, wherein the processor instructions, on execution, further cause the processor to:
prepare each of a set of normal priority jobs for execution upon reaching the predefined execution time, wherein the priority level assigned to each of the set of normal priority jobs is the normal priority level; and
executing each of the set of normal priority jobs upon completion of preparation.

17. A non-transitory computer-readable medium storing computer-executable instructions for preparing and executing jobs, the computer-executable instructions configured for:
receiving a set of jobs for execution, wherein each of the set of jobs is scheduled for execution at a predefined execution time, and wherein each of the set of jobs comprises an associated set of job constraints;
assigning a priority level to each of the set of jobs based on the set of job constraints, wherein the priority level is one of a high priority level or a normal priority level;
preparing each of a set of high priority jobs for execution prior to the predefined execution time, wherein the priority level assigned to each of the set of high priority jobs is the high priority level; and
executing each of the set of jobs at the predefined execution time.

18. The non-transitory computer-readable medium of claim 17, wherein for assigning the priority level, the computer-executable instructions are further configured for assigning, via one of a predefined logic or a classification model, the priority level to each of the set of jobs based on the set of job constraints.

19. The non-transitory computer-readable medium of claim 17, wherein the set of job constraints comprises a predecessor dependency chain, a successor dependency chain, a time required for preparation, a time required for execution, and an availability of resources for execution.

20. The non-transitory computer-readable medium of claim 17, wherein the computer-executable instructions are further configured for:
assigning a delay flag to each of the set of high priority jobs; and
detecting each of the set of high priority jobs through the delay flag to initiate preparation for job execution.
